(19) United States
(12) Patent Application Publication
(10) Pub. No.: US 2009/0219595 A1
(43) Pub. Date: Sep. 3, 2009

(54) Device for Reading Out Holograms

(75) Inventors: Jean-Christophe Olaya, Dresden (DE); Grigory Lazarev, Dresden (DE)

Correspondence Address: Saul Ewing LLP (Philadelphia), Attn: Patent Docket Clerk, 2 North Second St., Harrisburg, PA, 17101, US

(73) Assignee: SeeReal Technologies S.A., Munsbach (LU)

(21) Appl. No.: 12/394,773

(22) Filed: Feb. 27, 2009

(30) Foreign Application Priority Data
Feb. 29, 2008 (DE) 10 2008 000467.7

(51) Int. Cl. G03H 1/30; G03H 1/22

(52) U.S. Cl. 359/25; 359/32

(57) ABSTRACT

The invention relates to an apparatus for transmissively reading out holograms generated by writing light in an optical medium, in particular holograms generated in an optically addressable spatial light modulation device. For this purpose, the apparatus comprises an illumination device for emitting light and an optical system for directing the light from the illumination device onto the optical medium. In this case, the optical system is arranged in the beam path of the writing light.

### CROSS-REFERENCE TO RELATED APPLICATIONS

This application is based on and claims priority to German Application No. DE 10 2008 000467.7, filed Feb. 29, 2008, the entire contents of which are incorporated herein by reference.

### FIELD OF THE INVENTION

The invention relates to an apparatus for transmissively reading out holograms generated by writing light in an optical medium, in particular holograms generated in an optically addressable spatial light modulation device, comprising an illumination device for emitting light, in order to represent, in particular three-dimensional scenes in high-resolution in particular for an observer. Furthermore, the invention also relates to a method for transmissively reading out holograms.

### BACKGROUND OF THE INVENTION

Holography makes it possible to record and subsequently reestablish the amplitude and phase distributions of a wavefront. In this case, an interference pattern of coherent light reflected from an object and light coming directly from a light source is recorded on a recording medium, e.g. a photographic plate. If the interference pattern, also referred to as a hologram, is illuminated with coherent light, a three-dimensional scene arises spatially. In order to generate the hologram by means of known methods or techniques, a real three-dimensional object is usually used, the hologram then being referred to as a genuine hologram. However, the hologram can also be a computer-generated hologram (CGH).

As reversible recording media for CGHs, use is made of light modulators, such as, for example, LCD (Liquid Crystal Display), LCoS (Liquid Crystal on Silicon), EASLM (Electrically Addressed Spatial Light Modulator), OASLM (Optically Addressed Spatial Light Modulator), which modulate the phase and/or the amplitude of incident light.

Electrically addressable spatial light modulators (EASLM) are very often used in reproduction devices or displays. In this case, an EASLM can be defined as a spatial light modulator which is constructed from discrete elements which are connected to an electrical circuit and are likewise controlled via the latter. However, EASLMs for use in holographic reproduction devices for three-dimensional representation have considerable disadvantages, such as, for example, the limited number of modulation elements, also called pixels, the small filling factor and the relatively low resolution resulting therefrom.

In order that, however, a large three-dimensional scene can be offered or a large observer region made possible for the observer, the EASLM must have a large number of modulation elements or pixels which are arranged very close together in order that a high filling factor can be achieved. In practice, however, this can only be achieved with high complexity and is associated with above average costs with the result that good economic viability cannot be obtained.

Therefore, attempts have already been made to use optically addressable spatial light modulators (OASLM) for this purpose. An OASLM is a light modulator which can be used to generate an optically controllable change in the amplitude and/or phase transparency. It has considerable advantages over an EASLM, particularly in the case of application in a reproduction device. The principal advantage resides in its analogue behaviour or in the fact that it is not pixelated. This means that there are no discrete pixels and therefore no filling factor and no sampling interval. Consequently the resolution of an OASLM is significantly higher than that of an EASLM.

New types of OASLM technologies, for example colour-doped OASLMs, expect a resolution of 300 lp/mm to 1500 lp/mm and higher. With such a high resolution, it is possible to generate holographically high-quality reconstructions in conjunction with large observer regions in comparison with the prior art to date. In order to use such an OASLM for the representation of three-dimensional scenes to be reconstructed, however, it is necessary to write to the OASLM a hologram with correspondingly high resolution. For this purpose, it is known for holographic image data to be displayed on an EASLM, said image data being focused sequentially via a microlens arrangement onto different regions or segments of the OASLM, and the hologram thus being written there (Active Tiling). However, a high resolution is not achieved by imaging a hologram onto the OASLM. In order to obtain a high resolution, therefore it is necessary for the OASLM to have regions or segments which are not larger than 3 μm, by way of example. Moreover, the recording of the hologram does not yield high-quality results with scanning systems or deflection systems such as mirrors or prisms in the case of a corresponding segment size of the OASLM, such that these solutions are likewise disadvantageous. Moreover, most of the systems existing hitherto can only be used for current OASLM technology producing a resolution of 30 lp/mm to 100 lp/mm.

If a hologram has been written or recorded in an optical medium, the hologram has to be read out for the holographic reconstruction.

It is known that the holographic information recorded in the OASLM can be read out in different ways. The read-out light impinges on the OASLM, such that the content of the OASLM is read out and is represented for an observer e.g. via a Fourier optical assembly. If the OASLM is read in reflection, the light impinges on that surface of the OASLM which lies opposite the writing-in surface. For this purpose, the OASLM comprises an absorption layer in conjunction with a mirror, which prevent the impinging light from passing through the OASLM. Reproduction devices in which the OASLM is readout in reflection are known for example from U.S. Pat. No. 6,753,990 B1 or US 2005/0286117 A1. In the case of reading out the OASLM in reflection for representing a three-dimensional scene, image or object, the size of the reproduction device provided for this purpose is very extended, whereby said reproduction device is suitable only to a limited degree for example for holographic projection devices in the telecommunications sector, entertainment sector or else medical technology.

If the OASLM is readout in transmission, the light is directed onto the OASLM from the same side as the light which serves for recording or writing the hologram. When reading out the OASLM in transmission, however, there is the problem that elements which serve for recording or writing a hologram impair the readout of the hologram, that is to say influence the properties of the readout light in such a way that an error-free readout of the hologram from the OASLM cannot be achieved.

One possibility of reading out the hologram from the OASLM in transmission is known from WO 2007/132230 A1 which describes a holographic display comprising an OASLM. In this case, the display is constructed in such a way that the light used for recording or writing holographic information in the OASLM impinges on the OASLM at an angle. Light from a light source that emits the primary colour blue is used in this case. Light from a light source that emits red is used for reading out the OASLM, said light source being arranged in such a way that the red light impinges with nearly the same angle of incidence as the blue light. However, the two light sources are situated at different locations in the reproduction device. In this way, although optical elements which serve for writing the hologram do not or nearly do not influence the readout light, a compactly constructed reproduction device is not possible.

### SUMMARY OF THE INVENTION

Therefore, it is an object of the present invention to provide an apparatus and a method for transmissively reading out holograms from an optical medium, in particular from an optically addressable spatial light modulation device, with which optical elements which serve for writing a hologram do not adversely influence the properties of the readout light and a compact apparatus can be obtained.

The object is achieved with regard to the apparatus with the features of Claim 1 and with regard to the method with the features of Claim 19.

According to the invention, the object is achieved with regard to the apparatus by virtue of the fact that an optical system for directing the light from the illumination device onto the optical medium is arranged in the beam path of the writing light.

In order to meet the requirements of today's market particularly in the field of holographic three-dimensional representations, it is necessary, especially in devices with limited volume, such as e.g. in the telecommunications sector, for apparatuses in which a high-resolution optical medium, in particular an optically addressable spatial light modulation device (OASLM), is provided to be configured compactly in terms of their extent. This requirement is covered by the apparatus according to the invention. This is because the apparatus according to the invention for reading out holograms from the optical medium comprises an optical system which makes it possible to readout the optical medium in transmission, thereby obviating light sources and possible optical elements for reading out a hologram in the case of a reflectively embodied optical medium in the region of the reconstruction volume or on the opposite side of the optical medium with respect to the writing-in side, such that a compact construction of the apparatus and hence a compact construction of the entire reproduction device can be obtained.

In this case, the optical system is arranged in the writing beam path or in the beam path of the writing light with respect to the optical medium in such a way that optical elements used for recording or writing in the hologram or the holographic information in the optical medium do not adversely influence the properties of the readout light, with the result that the hologram can be readout completely and with high accuracy from the optical medium. It also goes without saying that the optical system provided for reading out the hologram does not adversely impair the profile of the writing light for recording the hologram or the holographic information, with the result that the hologram can be written with high resolution to the preferably optically addressable spatial light modulation device as optical medium advantageously in corresponding regions or segments.

The optical system is configured as light-transmissive in the case of simultaneous recording of a hologram on the optical medium. For the case where an optical medium with a permanently written hologram is to be readout, the optical system could also be only partly light-transmissive or even light-opaque.

The apparatus according to the invention can be used to readout in particular present-day OASLMs that are offered or available commercially, but also OASLMs that are imminent in the near future, such as colour-doped OASLMs for example.

It can be particularly advantageous if the illumination device is provided for emitting a readout light having a different wavelength and/or polarization state relative to the writing light, with the result that the writing light and the reading light do not mutually influence one another.

In one advantageous configuration of the invention it can be provided in this case that the optical system comprises microlenses, the microlenses having fields of view corresponding to the regions of the optical medium in which holographic information are written in. A microlens within the meaning of the invention is a lens whose diameter is principally in the millimetre range, in particular ≦1 mm. In this case, the microlenses serve for light beam guiding, in particular, with the result that the entire optical medium can be illuminated uniformly and completely. For it is only by this means that the holographic information can be read out completely and precisely.

It can furthermore be advantageous if the illumination device has a light source arrangement arranged—in the light direction—upstream of the microlenses. In this case, the number of light sources corresponds to the number of microlenses, with the result that each microlens is assigned a light source. It is particularly advantageous if the light sources are arranged in the object-side focal plane of the microlenses. For what is achieved thereby is that the microlenses serve as a collimator and thus collimated light impinges on the optical medium. In this way, the optical medium is illuminated uniformly over the whole area. An extended apparatus, for example if the optical medium is illuminated for readout on the opposite side with respect to the side for writing in the hologram, can be particularly avoided by means of an apparatus embodied in this way.

In this case, it can be particularly advantageous if the light sources of the reading light are embodied as at least partly transmissive. This means that the light sources are partly transparent, completely transparent or else at least the substrate of the light sources is partly or completely transparent. Such an embodiment of the light sources makes it possible to achieve a simultaneous recording and readout of holograms in/from the optical medium, whereby e.g. a real-time representation of advantageously moving three-dimensional scenes can be realized. Thus, the light sources can already be arranged in the beam path during the recording of the hologram on the optical medium, without influencing the light impinging on the microlenses. In this case, the light sources used can be organic light-emitting diodes (OLED) since the latter have a transparent substrate or are transparent to defined wavelengths of the light, though it goes without saying that other light sources can also be used provided that they are at least approximately transparent.

A further possibility of reading out the hologram from the same side as it is written in can consist in the fact that the microlenses are embodied as polarization-dependent microlenses and have a birefringence such that light of a first polarization component can be influenced in terms of its wavefront and light of a second polarization component cannot be influenced in terms of its wavefront. By means of an apparatus according to the invention that is configured in this way, without additional elements for reading out the hologram, the hologram can be recorded on the optical medium and at the same time also be readout again. This means that orthogonally polarized light is used for recording and reading out the hologram. However, the wavelengths used have to be different, which necessitates the use of, for example, two light sources and/or two illumination devices. The light source(s) used for reading out the hologram can be provided for example in the illumination device used for recording the hologram. In this way, too, the optical medium can be illuminated for reading out the hologram, whereby this apparatus can find application especially in devices that are severely limited in the volume.

A third possibility of reading out a hologram from the optical medium can advantageously be seen in the fact that the optical system has at least one element which deflects readout light, in particular a beam splitter element, for guiding the readout light from the illumination device onto the optical medium, with the result that the light is directed via the deflecting element, e.g. a beam splitter element, in the direction of the optical medium in order to illuminate the latter. In this way, an oblique arrangement of the illumination device with respect to the optical medium, as known e.g. from WO 2007/132230 A1, is likewise avoided, whereby the illumination device can be arranged in space-saving fashion for readout.

An alternative possibility thereto can consist in the fact that a plurality of beam splitter elements arranged upstream of individual regions of the optical medium are arranged in such a way that non-deflected light from the previous beam splitter element impinges on the next beam splitter element. A respective beam splitter element of the arrangement of beam splitter elements is thus assigned to at least one region or segment of the optical medium. In order to minimize or to avoid light losses in this case, the beam splitter elements can be embodied as polarization-sensitive beam splitter elements.

In the case of this possibility of guiding the light onto the optical medium, it is advantageous if the beam splitter embodiments are embodied with such a different splitting ratio that the light impinging on the individual regions of the optical medium has the same intensity. It can therefore be ensured that the same light intensity is present on all regions or segments of the optical medium and the regions are illuminated uniformly, with the result that no information is lost when reading out the hologram.

In one advantageous configuration of the invention, it can furthermore be provided that the illumination device has a light source in conjunction with a shutter which can be used to control the illumination on the optical medium. As a result, by switching on the in particular ferroelectric shutter, the illumination of the optical medium, in particular of the regions or segments of the optical medium, can be controlled in accordance with the required information with regard to the hologram, such that, depending on the information written in, the requisite regions of the optical medium, in particular of the OASLM, are illuminated.

As an alternative, instead of one light source in conjunction with a shutter, it can also advantageously be provided that the illumination device comprises a multiplicity of light sources, the optical medium being able to be exposed depending on the controlling of individual light sources. If a plurality of light sources are provided in the illumination device, then the individual regions or segments of the optical medium can be illuminated in accordance with the required information by the switching of the light sources. Consequently, a shutter is no longer necessary since the light sources perform this function.

The object of the invention is furthermore achieved by means of a method for transmissively reading out holograms generated by writing light in an optical medium, in particular holograms generated in an optically addressable space light modulation device, readout light being guided from an illumination device onto the optical medium, wherein the readout light is emitted onto the optical medium via an optical system arranged in the beam path of the writing light, the readout beam path being at least partly superimposed on the writing beam path.

In this way, from the optical medium, preferably an optically addressable spatial light modulation device (OASLM), a hologram is readout in transmission, the optical system influencing the properties of the impinging light in such a way that a readout can be effected without loss of information. In this case, the hologram is written in and read out advantageously in real time. By means of the method according to the invention and in particular by the at least partial superimposition of the readout beam path with the writing beam path, holograms can thus be readout simply and rapidly even in devices with limited volume in transmission from high-resolution optical media with advantageously a potential information density of 300-1500 lp/mm and higher.

Advantageously, non-coherent light is used for recording a hologram on the optical medium and sufficiently coherent light or light which is coherent in sufficiently large regions is used for reading out the hologram. In this case, it is important that the wavelengths differ.

Further configurations of the invention emerge from the rest of the dependent claims. The principle of the invention is explained below on the basis of the exemplary embodiments described in greater detail in the figures.

### BRIEF DESCRIPTION OF THE DRAWINGS

FIG. 1 shows a schematic view of a first embodiment of an apparatus according to the invention for reading out holograms from an optical medium, in side view;

FIG. 2 shows a schematic view of a second embodiment of the apparatus according to the invention in conjunction with the writing in of a hologram to the optical medium, in side view;

FIG. 3 shows a schematic view of a third embodiment of the apparatus according to the invention in conjunction with the writing in of a hologram to the optical medium, in side view; and

FIG. 4 shows a schematic view of a fourth embodiment of the apparatus according to the invention in conjunction with the writing in of a hologram to the optical medium, in side view.

### DETAILED DESCRIPTION

The construction and the functioning of an apparatus for reading out a hologram from an optical medium are described below. For this purpose, the optical medium is assumed to be an optically addressable spatial light modulation device, designated hereinafter as OASLM, from which a hologram is readout in transmission. In this case, the OASLM can be an OASLM already known from the prior art, also including a colour-doped OASLM, which is suitable for reading out the hologram in transmission. Such OASLMs generally comprise, inter alia, a photosensitive layer and wavelength-selective layers. Additional layers, such as glass layers, for example, can likewise be present. The construction of such an OASLM is generally known and will not be presented any further here. It goes without saying that other high-resolution reversible optical media can also be used instead of the OASLM.

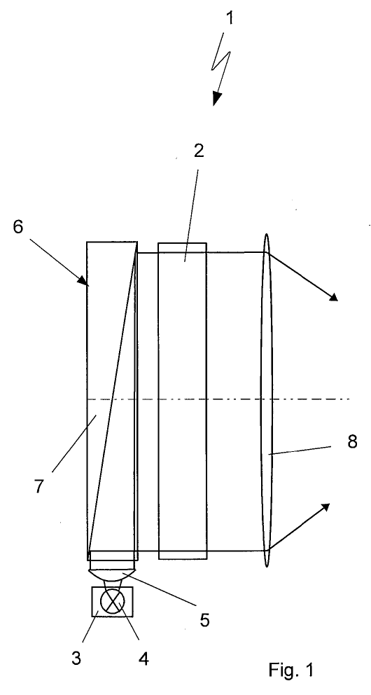

FIG. 1 illustrates a first embodiment of the basic construction of an apparatus 1, the apparatus 1 being shown in a very simplified fashion in side view. For reading out a hologram from the OASLM 2 in transmission, the apparatus 1 has an illumination device 3, which in FIG. 1 provides a light source 4 which emits sufficiently coherent light. The light source used can be for example a laser or else a light-emitting diode. For expanding and collimating the light emitted by the light source 4, an optical element 5 is provided downstream of the light source 4 in the light direction. In this case, said optical element 5 can be integrated into the illumination device 3, but this is not a condition. The sufficiently collimated light or the sufficiently collimated light beams are then guided onto the OASLM 2 via an optical system 6 for the purpose of reading out a hologram stored in the OASLM 2. The optical system 6 comprises an element 7 for deflecting readout light, a beam splitter in this exemplary embodiment. In this case, the beam splitter element 7 extends over the entire extent of the OASLMs 2. Such an embodiment of the apparatus 1 can be used for example if the hologram is readout from the OASLM 2 temporally independently of the writing in process. This can be the case e.g. if a static advantageously three-dimensional scene is intended to be represented or an optical medium acquired permanently with a hologram is intended to be readout. Here it is then possible, after the hologram has been written into the OASLM 2, for the beam splitter element 7 to be pivoted or introduced into the writing beam path.

It is however also possible, of course, for the beam splitter element 7 already to be arranged in the writing beam path when the hologram is written in or recorded. In this way, additional devices for pivoting in the beam splitter element 7 are not necessary, whereby the overall construction of the apparatus becomes more compact. In this case, the beam splitter element 7 is embodied in such a way that it does not influence the properties of the light used for writing in. As a result, a hologram can be written into and readout from the OASLM 2 in real time. Consequently, preferably moving three-dimensional scenes can be holographically generated and represented for one or more observers.

The holographic reconstruction of a scene can be effected by means of a field lens 8, here embodied as a Fourier lens, which is arranged downstream of the OASLM 2 in the light direction. During the reconstruction operation, the readout light is guided onto the OASLM 2, with the result that the light is modulated by the hologram and the hologram is thus readout. The light, after its modulation, then impinges on the Fourier lens 8, which generates the Fourier transform in its image-side focal plane. It is also possible to code the properties of the Fourier lens 8 into the OASLM 2 if the latter has a correspondingly high resolution for this purpose. In this case, it is not necessary to provide a Fourier lens downstream of the OASLM 2 in the light direction.

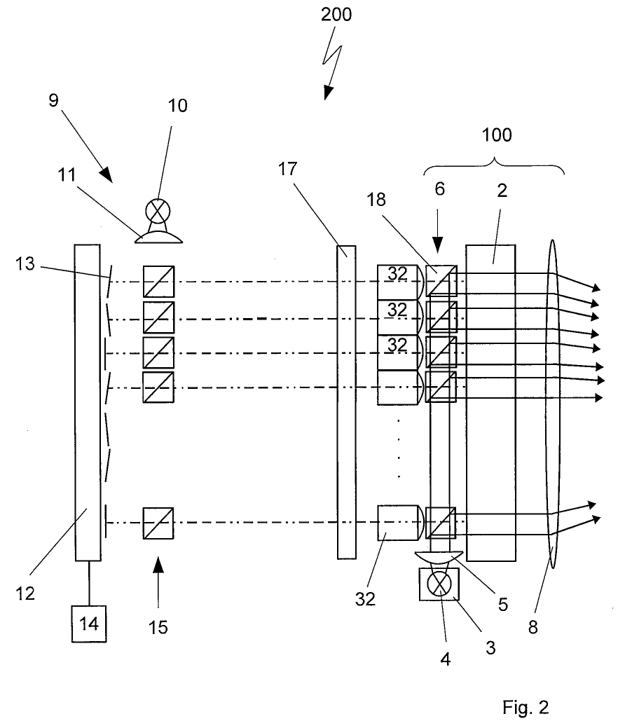

An alternative embodiment is shown by the apparatus 100 for reading out a hologram from the OASLM 2 in FIG. 2, FIG. 2 also illustrating the writing of the hologram to the OASLM 2, the overall apparatus being provided with the reference symbol 200. In this case, identical parts from FIG. 1 also have the same reference symbols. In the text below, reference is firstly made to the direct writing in of the hologram to the OASLM 2.

For writing in a hologram, an illumination device 9 is provided, which has at least one light source 10. At least one optical element 11 serving for collimating the light emitted by the light source 10 is arranged downstream of the light source 10 in the light direction. In this case, said optical element 11 can be integrated into the illumination device 9, but this is not a condition. The collimated light is then directed onto an image source 12, which is advantageously embodied in two-dimensional fashion, though the image source 12 can, of course, also be embodied in one-dimensional fashion. The image source 12 in this case has a plurality of modulation elements 13 in the form of micromirrors which are controlled for the modulation of the impinging light by means of a control device 14. Depending on the required hologram to be written in or recorded on the OASLM 2, the modulation elements 13 of the image source 12 can be correspondingly tilted and/or axially displaced. Alongside an arrangement of micromirrors as image source 12 it is also possible to provide an arrangement of variable prisms, the prism angle of which is controllable, or a deformable membrane mirror.

In this case, the light emitted by the light source 10 is guided via an arrangement of a plurality of beam splitter elements 15 in the beam path onto the modulation elements 13 of the image source 12, such that a respective beam splitter element is assigned to at least one modulation element 13. That is to say that a beam splitter element is assigned to each modulation element 13 of the image source 12 or only to each one-dimensional arrangement of modulation elements 13 of the image source 12. It follows from the latter that the beam splitter element is not embodied as a beam splitter cube, for example, but rather as a beam splitter rod. In this case, the individual beam splitter rods or beam splitter cubes can be arranged horizontally one above another and/or vertically alongside one another, depending on the arrangement of the illumination device 9. In this way, a beam splitter rod then extends over an entire column or row of modulation elements 13. Smaller beam splitter rods which extend only over a specific number of modulation elements 13 in each case are also conceivable. In order that all modulation elements 13 of the image source 12 are illuminated uniformly with light of the same intensity and consequently without loss of light, care must be taken to ensure that the beam splitter elements have a correspondingly different splitting ratio provided for this purpose. If the beam splitter elements are embodied as beam splitter rods and arranged horizontally one above another, then it is sufficient for one light source 10 to be provided for illuminating the modulation elements 13. However, if the beam splitter elements are embodied as beam splitter cubes or as beam splitter rods arranged vertically alongside one another, then it is provided that each column or row, depending on the arrangement of the illumination device 9 with respect thereto, is illuminated by a light source 10. Consequently, a multiplicity of light sources 10 are to be provided in the case of the illumination of an image source 12 embodied in two-dimensional fashion.

Instead of an arrangement of a plurality of beam splitter elements 15, the light can also be directed or guided onto the modulation elements 13 via one beam splitter element extending over the entire image source 12, whereby the entire apparatus 200 can be configured more compactly.

The light from the light source(s) 10 is sufficiently collimated by means of the optical element(s) 11 and then impinges on the row of a plurality of beam splitter elements or beam splitter cubes which faces the optical element(s) 11 or on a beam splitter rod of the arrangement 15, which guide the light onto the image source 12.

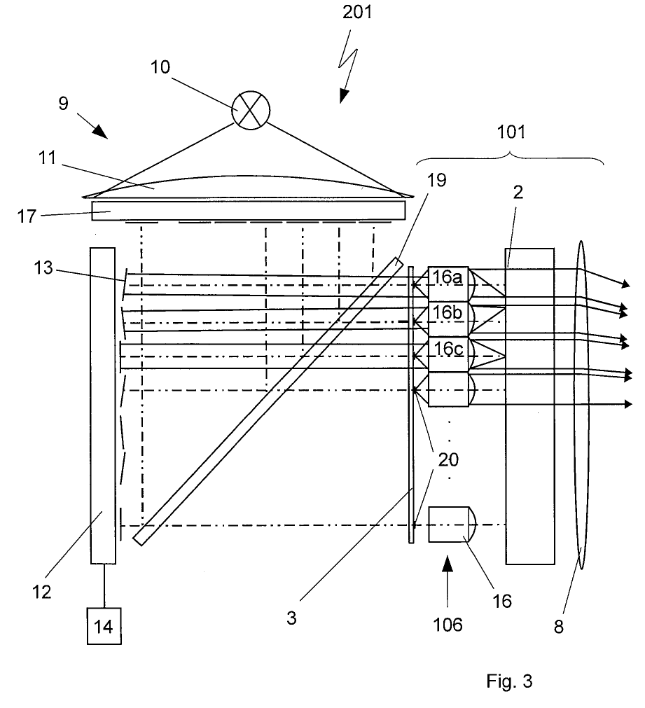

After the modulation of the light, the latter is reflected in the direction of an arrangement of microlenses or micro-objectives 32, the light impinging on the individual microlenses 32 in collimated fashion. The number of microlenses 32 advantageously corresponds to the number of modulation elements 13 of the image source 12. In this case, the microlenses 32 are arranged at a distance from the OASLM 2, such that the image focal points of the individual microlenses 32 lie on the OASLM 2. In this case, the light that has been modulated and reflected by each modulation element 13 can be focused onto the OASLM 2 by means of the corresponding microlens 32, whereby the holographic information or the hologram can be written in directly. Since each microlens or micro-objective 32 has a certain field of view, the writing in region of the holographic information into the OASLM 2 can be defined by the field of view by means of tilting of the corresponding modulation element 13. This means that each microlens 32 can focus the light beam that impinges depending on the tilting of the modulation element 13 onto the OASLM 2 only in a region or segment predefined by the field of view. This principle is referred to as angle-to-linear conversion. By way of example, a first light beam is reflected at a specific angle and then focused by a microlens 16a (here it would be the microlens 32) below the optical axis of the microlens 16a in the focal plane, as can be seen with reference to FIG. 3. A second light beam is reflected in a different direction, with the result that a microlens 16b focuses said beam above the optical axis into the focal plane. A third light beam, which impinges on a microlens 16c parallel to the optical axis, is in this case focused by said microlens onto the optical axis at its focal point. Consequently, the focal point moves back and forth in a predetermined region on the OASLM 2 when the holographic information is written in. This in turn affords the advantage that with the use of microlens 32 (or 16 in accordance with FIG. 3) having a relatively large field of view, the number of required modulation elements 13 of the image source 12 can be lower than in the case of microlenses 32 (or 16) having a small field of view. For with a microlens 32 having a larger field of view it is therefore also possible to cover a larger region on the OASLM 2. The higher the required resolution of the optical assembly used for writing in the hologram, the smaller also its field of view. However, it is always advantageously possible to use a low-resolution image source 12 for recording a high-resolution hologram in the OASLM 2.

For writing the hologram into the OASLM 2, the pictured light source 10 emits light which impinges on the microlenses 32 after the modulation on the image source 12, the writing beam path not being illustrated in FIG. 2 and only being indicated in FIG. 3. In order that light, if required, impinges only on desired microlenses 32, a shutter 17, for example a ferroelectric shutter, can advantageously be arranged upstream of the microlens 32 in the light direction, here between the beam splitter elements and the microlenses 32. The shutter 17 is switched on depending on the required holographic information. With a setting pattern of the modulation elements 13 only a small region in the OASLM 2 is written to. In order that a complete hologram can be generated the modulation elements 13 have to be controlled multiply such that holographic information can be completely written into the OASLM 2. If only the region corresponding to the field of view of a microlens 32 is written in completely, then this region can be e.g. a subhologram. It can also be possible, of course, that a complete hologram is written in a region corresponding to the field of view of a microlens 32.

In FIG. 2 the readout is likewise effected from the same side of the OALSM 2 as the writing in or recording of the hologram. The problem in the case of this apparatus 200 is that it is nearly impossible to illuminate the OASLM 2 with collimated light over the whole area by means of the illumination device 9, since this light although it is collimated has to pass through the microlenses 32. The microlenses 32 would accordingly focus this light, such that the OASLM 2 is not illuminated areally. Light beams converting onto the microlenses 32 would also define only a small aperture diameter upon impingement, with the result that the region illuminated on the OASLM 2 is likewise small. In order to avoid such disadvantages, the apparatus 100 is provided for reading out the hologram, this apparatus comprising the OASLM 2, the optical system 6 and the field lens 8 in this exemplary embodiment. The optical system 6 is arranged between the microlenses 32 and the OASLM 2 and has a plurality of beam splitter elements 18 which form an arrangement. In this case, each region or segment on the OASLM 2 which is defined by means of the field of view of a microlens 32 is assigned a beam splitter element 18 in order that these regions or segments of the OASLMs 2 can also be illuminated over the whole area for the purpose of reading out the hologram. This again means here, too, that the individual beam splitter elements 18 are arranged horizontally one above another and vertically alongside one another, in accordance with the statements made with regard to the arrangement of beam splitter elements 15 for illuminating the image source 12. Each column or row of the arrangement of beam splitter elements 18 is illuminated by the illumination device 3. This means that each row or column of the beam splitter elements 18 is illuminated by a light source 4, which can advantageously be embodied as a laser or light-emitting diode and emits sufficiently coherent light, with the result that non-deflected light from the previous beam splitter element 18 impinges on the next beam splitter element 18. Here, too, this light source 4 is assigned an optical element 5 for expanding or collimating the light. In order that nearly no light losses occur in the course of light passing through the individual beam splitter elements 18, the individual beam splitter elements 18 should have a correspondingly different splitting ratio in this case, too. The splitting ratio increases the greater the distance of the beam splitter element 18 from the light source 10. Light of different wavelengths is used here during the recording or writing in and during the readout of the hologram.

Since, moreover, the optical system 6 and therefore the beam splitter elements 18 are already arranged in the writing beam path of the apparatus 200 during the recording of the hologram, they must not adversely influence the light focused onto the OASLM 2 by the microlenses 32 during recording. Therefore, the optical system 6 can also advantageously have polarization-sensitive beam splitter elements which are arranged instead of the beam splitter elements 18 between the microlenses 32 and the OASLM 2. Such a beam splitter element, expressed in general terms, comprises two prisms having different refractive indices for horizontally and vertically polarized light. This means that light in one polarization direction is transmitted and light in the other polarization direction is refracted. What can be achieved in this way is that the direction of the light reflected by the modulation elements 13 of the image source 12 is not influenced by the beam splitter elements and the light guided from the light source 4 via the optical element 5 onto the polarizing beam splitter elements is reflected towards the OASLM 2. By way of example, one prism can have a higher refractive index for the horizontal polarization direction, such that this light beam experiences total internal reflection and leaves the beam splitter element on a different path from the vertically polarized light beam. In addition, the wavelengths for writing in and for reading out can be different. As can be seen from FIG. 2, the readout beam path is superimposed on the writing beam path in part, to be precise in regions downstream of the microlenses 32.

An alternative possibility of reading out the hologram in transmission is shown by the apparatus 201 in FIG. 3, this apparatus 201 comprising the apparatus 101 for reading out the hologram and simultaneously representing the writing in of the hologram to the OASLM 2. In this case, parts known from FIG. 1 or FIG. 2 have the same reference symbols here, too. Firstly, the writing in of the hologram will be discussed just briefly. In this case, the illumination device 9 comprises only one light source 10, which can advantageously be embodied as a light-emitting diode. In this case, too, said light source 10 is again assigned an optical element 11 for expanding or collimating the light. In order that light also impinges only, if required, on specific modulation elements 13 of the image source 12, the shutter 17 is arranged downstream of the optical element 11 in the light direction, said shutter being switched depending on the modulation element 13 to be activated. In other words, if light is not intended to impinge on all the modulation elements 13, the shutter 17 is controlled and switched in such a way that only some shutter openings transmit light, with the result that light also impinges only on some modulation elements 13 and microlenses 16. Depending on how the hologram to be recorded or written on the OASLM 2 is defined, the shutter 17 is controlled such that light is directed only onto some or onto all of the modulation elements 13, and the corresponding holographic information is then written in directly to the OASLM 2 by means of said light. Instead of an arrangement of beam splitter elements 15 in accordance with FIG. 2 for directing the light onto the image source 12, here only one beam splitter element 19 is illustrated, where it goes without saying that the arrangement of a plurality of beam splitter elements 15 can also be used. The principle of directly recording a hologram on the OASLM 2 is effected here in the manner already described with respect to FIG. 2.

The readout of the hologram from the OASLM 2 is effected in transmission in this case, too. Instead of a plurality of beam splitter elements 18 in accordance with FIG. 2, the optical system 106 comprises an arrangement of microlenses 16, where the microlenses 16 can be embodied in accordance with the microlenses 32 according to FIG. 2. The illumination device 3 is arranged in the writing beam path and comprises a light source arrangement 20 arranged upstream of the microlenses 16 in the light direction. In this case, the light sources 20 are embodied as organic light-emitting diodes (OLED), though other light sources are also possible, of course. A direct positioning of the arrangement of organic light-emitting diodes 20 in the plane of the OASLMs 2 does not obtain the required effect, owing to the spatial incoherence of such light sources. It is particularly advantageous if the arrangement of organic light-emitting diodes 20 is arranged in the object-side focal plane of the microlenses 16 as illustrated in FIG. 3. In this way, the OASLM 2 can be illuminated with sufficiently collimated light and the hologram can be readout completely. For reading out the hologram, organic light-emitting diodes with a correspondingly high degree of coherence should be chosen, such that enough sufficiently coherent light for readout impinges in the region of the subholograms or on the segments of the OASLM 2. Light of different wavelengths is used for writing in and reading out the hologram.

Since the arrangement of organic light-emitting diodes 20 is already arranged in the beam path of the apparatus 201 when the hologram is recorded on the OASLM 2, care should be taken to ensure that the organic light-emitting diodes 20 are embodied as at least partly transmissive or the substrate of the light source is at least partly transparent, in order that during the recording of the hologram the light reflected by the modulation elements 13 of the image source 12 is not vignetted or adversely influenced, with the result that an optimum recording of the hologram is ensured. The organic light-emitting diodes 20 are self-luminous and are distinguished by a low power requirement. Moreover, they are extremely flat, whereby the apparatus 201 or the apparatus 101 is not unnecessarily extended in its size. By virtue of the furthermore very short reaction times or response times in the ms range, they consequently serve as an optimum light source for illuminating the OASLM 2. It goes without saying that alongside organic light-emitting diodes other light sources can also be used provided that they are embodied as at least partly transmissive.

In order to readout the hologram from the regions of the OASLM 2 which are defined for recording or writing in, the organic light-emitting diodes 20 of the illumination device 3 are switched on, such that readout light impinges on each individual microlens 16, 16a, 16b, 16c etc. In this case, the individual microlenses 16 of the optical system 106 convert the impinging light into collimated light that impinges on the OASLM 2 as optical medium, as can be seen from FIG. 3. Consequently, the readout beam path is partly superimposed on the writing beam path in this case, too. Since light of different wavelengths is used for writing in and for reading out, the readout does not influence the recording or writing in of the hologram, such that, during the writing in of the hologram the microlenses 16 focus the impinging light on the regions of the OASLMs 2 which are defined by the field of view of the microlenses 16. In this way, the microlenses 16 of the optical system 106 are simultaneously provided for recording the hologram in and for reading out the hologram from the OASLM 2 as optical medium. In this case, too, the reconstruction of the hologram is effected by means of the field lens 8 embodied as a Fourier lens.

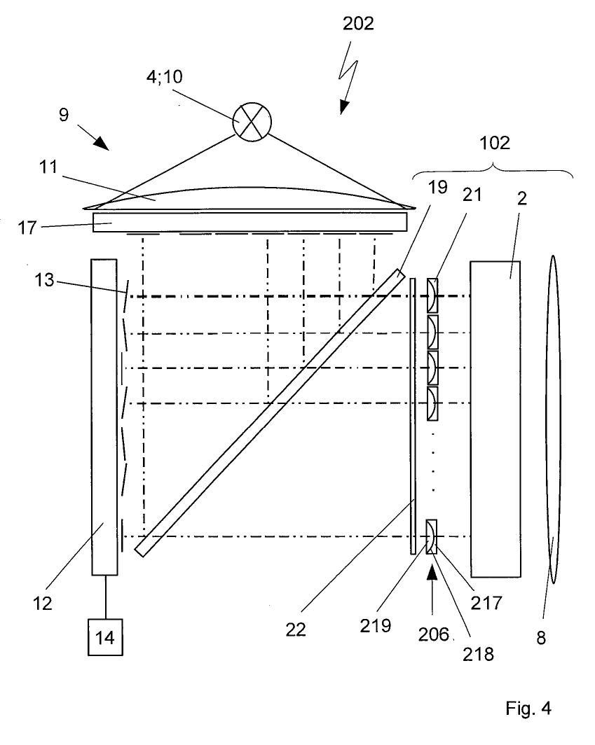

Alongside the possibilities already described above, the readout of a hologram from the OASLM 2 can also be effected by means of the apparatus 102 illustrated in FIG. 4. In this case, the basic construction of the overall apparatus 202 corresponds to that in FIG. 3. Instead of the simply embodied microlenses 16 in accordance with FIG. 3, however, the optical system 206 here comprises microlenses embodied as polarization-dependent or polarization-sensitive microlenses 21. In this case, the individual polarization-dependent microlenses 21 have a birefringence such that, as seen generally, light of a first polarization component is directed in a first direction and light of a second polarization component is directed in a second direction, which differs from the first direction, or, in the present case, the light of a first polarization component is influenced in terms of its wavefront and light of a second polarization component is not influenced in terms of its wavefront. In this case, at least two light sources are used which emit light of different wavelengths and have two polarization directions. This means that orthogonally polarized light is used for recording and reading out the hologram. For this purpose, each individual polarization-dependent microlens 21 is constructed approximately as follows. A substrate (not illustrated) is provided with an isotropic material 217, on which a microstructured interface 218 is formed. A birifringent material 219 having a defined birifringent optical axis direction is applied on the microstructured interface 218. A further substrate (not illustrated) is applied to the birifringent material 219 in order to enclose the latter. It goes without saying that modifications of the embodiment of such a microlens 21 are possible.

Moreover, the optical system 206 has a switchable polarizer 22 upstream of the polarization-dependent microlenses 21 in the light direction, which polarizer can switch between a first polarization state, which transmits light of the first polarization component, and a second polarization state, which transmits light of the second polarization component. Such polarizers 22 are generally known and will therefore not be described in any further detail. Here, too, the polarization-dependent microlenses 21 of the optical system 206 simultaneously serve for recording and for reading out the hologram. For recording the hologram on the OASLM 2, the polarizer 22 is switched into a first polarization state, such that the microstructured interface 218 acts as a lens and thus focuses the light reflected by the modulation elements 13 of the image source 12 into a region on the OASLM 2. For reading out the hologram from the OASLM 2, the polarizer 22 is then switched into a second polarization state, whereby the microstructured interface 218 has essentially no optical effect, with the result that the polarization-dependent microlens 21 acts as a simple transparent plane plate. The light thus impinging on the polarization-dependent microlens 21 for readout is thereupon not influenced in terms of its light direction and therefore remains sufficiently collimated. This means that the polarization-dependent microlenses 21 are controlled by means of a control device (not illustrated) in such a way that they act as a focusing optical assembly for recording the hologram and as a plane plate for reading out the hologram. The collimated light then impinges areally on the regions defined by the fields of view of the polarization-dependent microlenses 21 or on the segments of the OASLM 2 that are defined by the fields of view. In this case, the readout beam path is superimposed on the writing beam path completely rather than only partly, as in FIGS. 2 and 3. By means of a field lens 8, the reconstruction of the hologram or of the holographic information is then effected.

Furthermore, it is pointed out once again that the optical medium, here the OASLM 2, can have individual regions or segments in which the holographic information is written in and from which said information can also be readout again. In this case, the optical medium as hologram storage device can be constructed out of a plurality of individual media. This means, in the case of a OASLM 2 as optical medium, that it can be composed of a plurality of small OASLM and thereby forms a large OASLM 2. The OASLM 2 in FIGS. 1 to 4 can therefore also be a OASLM composed of a plurality of OASLM.

It is also possible to use secondary light sources instead of the use of primary light sources. This means that it is also possible to use imagings of the light sources for illuminating the optical medium 2 and/or the image source 12.

In all the embodiments illustrated in FIGS. 2 to 4, however, care should be taken to ensure that light of different wavelengths and/or polarization states is used for recording and for reading out the hologram, in order to prevent the light during recording and readout from being able to influence one another and the information from thereby being destroyed. Since this is a prerequisite, it is possible to readout the hologram in transmission in such a way that the optical system 6, 106, 206 used for the readout can be arranged in the writing beam path, such that the two beam paths, writing beam path and readout beam path, can be at least partly superimposed without information provided for writing to the OASLM 2 being lost or altered.

For all the embodiments of the apparatus according to the invention which are illustrated in FIGS. 2 to 4 it holds true that non-coherent light is used for directly recording a hologram on the OASLM 2 and coherent or sufficiently coherent light is used for reading out the hologram. In both cases the recording and also the readout of the hologram are advantageously effected in real time. The illumination of the modulation elements 13 of the image source 12 can also be effected, of course, without the use of the beam splitter element 19 or a plurality of beam splitter elements 15, in which case the arrangement of the light source or light sources 10 of the illumination device 9 or the illumination device 9 per se has to be performed accordingly, for example at an angle with respect to the image source 12.

Should it be necessary for the hologram to be read out from the OASLM 2 in coloured fashion, then it is possible to provide for example three light sources corresponding to the primary colours red, green and blue instead of a monochromatic light source 4, 20 in the apparatuses 1, 100, 101 and 102. If a plurality of monochromatic light sources 4 are provided in the apparatuses 1, 100, 101 and 102, then these must correspondingly be replaced by a plurality of light sources of the primary colours. The coloured readout of the hologram can thereupon be effected simultaneously or sequentially.

It goes without saying, however, that further embodiments of the apparatus, FIGS. 1 to 4 only representing preferred embodiments, are possible, combinations of the embodiments among one another also being conceivable. Modifications of the embodiments shown are possible, therefore, without departing from the scope of the invention.

As a result of the readout (and also recording) of the hologram in real time, the apparatus 1, 100, 101 and 102 (and also the apparatuses 200, 201 and 202) can be used particularly advantageously in holographic reproduction devices for the reconstruction of advantageously three-dimensional scenes. If the hologram is written into the OASLM 2 with a high resolution, as for example in accordance with FIGS. 2 to 4, it is possible to generate high-quality reconstructions. In addition, these reconstructions can then be observed advantageously three-dimensionally by means of a large observer window. The observer can thus observe the reconstructions with both eyes.

Possible fields of use for the apparatus 1, 100, 101, 102 (and also of the apparatuses 200, 201, 202) can be displays for a two- and/or three-dimensional representation for the private and work sectors, such as, for example, for computers, television, electronic games, automotive industry for displaying information or entertainment, medical technology, here in particular for minimally invasive surgery or the spatial representation of data obtained by tomography, or else for military technology, for example for representing terrain profiles. It goes without saying that the present apparatus 1, 100, 101, 102 (and also the apparatuses 200, 201, 202) can also be used in other areas that have not been mentioned here.

We claim:

1. Apparatus for transmissively reading out holograms generated by writing light in an optical medium, in particular holograms generated in an optically addressable spatial light modulation device, comprising:
an illumination device for emitting light; and
an optical system directing the light from the illumination device onto the optical medium, said light beam being arranged in the beam path of the writing light.

2. Apparatus according to claim 1, wherein the optical medium has individual regions in which holographic information is written.

3. Apparatus according to claim 1, wherein the illumination device is provided for emitting a read-out light having a different wavelength and/or polarization state relative to the writing light.

4. Apparatus according to claim 1, wherein the optical system has microlenses.

5. Apparatus according to claim 4, wherein the illumination device comprises a light source arrangement arranged—in the light direction—upstream of the microlenses, in particular in the object-side focal plane of the microlenses.

6. Apparatus according to claim 5, wherein the light sources are embodied as organic light-emitting diodes.

7. Apparatus according to claim 5, wherein the light sources are embodied at least partly transmissive.

8. Apparatus according to claim 4, wherein the microlenses are embodied as polarization-dependent microlenses and comprise a birefringence such that light of a first polarization component can be influenced in terms of its wavefront and light of a second polarization component cannot be influenced in terms of its wavefront.

9. Apparatus according to claim 8, wherein the optical system comprises a switchable polarizer, which can be switched between a first polarization state, which transmits light of the first polarization component, and a second polarization state, which transmits light of the second polarization component.

10. Apparatus according to claim 1, wherein the optical system comprises at least one element which deflects read-out light, in particular a beam splitter element, for guiding the read-out light from the illumination device onto the optical medium.

11. Apparatus according to claim 10, wherein a plurality of beam splitter elements arranged upstream of individual regions of the optical medium are arranged in such a way that non-deflected light from the previous beam splitter element impinges on the next beam splitter element, the beam splitter elements having such a different splitting ratio that the light impinging on the individual regions of the optical medium contains the same intensity.

12. Apparatus according to claim 4, wherein the microlenses each comprise a field of view corresponding to the regions of the optical medium in which holographic information is written.

13. Apparatus according to claim 1, wherein the illumination device comprises a light source in conjunction with a shutter which can be used to control the illumination on the optical medium.

14. Apparatus according to claim 1, wherein the illumination device comprises a multiplicity of light sources, the optical medium being able to be exposed depending on the controlling of individual light sources.

15. Apparatus according to claim 1, wherein said optical medium comprises an optically addressable spatial light modulation device.

16. Method for transmissively reading out holograms generated by writing light in an optical medium, in particular holograms generated in an optically addressable space light modulation device, read-out light being guided from an illumination device onto the optical medium, comprising:
emitting the read-out light onto the optical medium via an optical system arranged in the beam path of the writing light, the read-out beam path being at least partly superimposed on the writing beam path.

17. Method according to claim 16, further comprising:
controlling polarization-dependent microlenses of the optical system by means of a control device in such a way that they act as a focusing optical assembly for recording the hologram and as a plane plate for reading out the hologram.

18. Method according to claim 17, wherein orthogonally polarized light is used for recording and for reading out the hologram from the optical medium.

19. Method according to claim 16, further comprising:
switching on light sources of the illumination device which are arranged at object-side focal points of microlenses of the optical system, the microlenses of the optical system converting the light impinging from the light sources into collimated light that impinges on the optical medium for reading out the hologram.

20. Apparatus for holographically reconstructing scenes comprising an apparatus according to claim 1.
